(19) United States
(12) Patent Application Publication
(10) Pub. No.: US 2007/0231515 A1
(43) Pub. Date: Oct. 4, 2007

(54) TRANSPARENT ORNAMENT

(76) Inventor: Sang-Ik Yeom, Seoul (KR)

Correspondence Address: CANTOR COLBURN, LLP, 55 GRIFFIN ROAD SOUTH, BLOOMFIELD, CT, 06002, US

(21) Appl. No.: 11/535,099

(22) Filed: Sep. 26, 2006

(30) Foreign Application Priority Data
Apr. 1, 2006 (KR) 1020060029952

(51) Int. Cl. B31B 45/00

(52) U.S. Cl. 428/34.1; 428/13

(57) ABSTRACT

The present invention relates to a polyhedral transparent ornament functioning as a pictorial display, comprising; a cubic transparent body which includes a bottom surface formed in a truncated triangular planar shape by cutting off an optional vertex portion of the cubic transparent body, three planar surfaces each formed adjacent to edges of the bottom surface, and three viewing surfaces each formed adjacent to edges of the planar surfaces; and a plurality of pictorial films each formed on a corresponding one of the planar surfaces, whereby the pictorial films are selectively viewed through the viewing surfaces.

### BACKGROUND OF THE INVENTION

1. Field of the Invention

The present invention relates to a transparent ornament, and more particular, to a polyhedral transparent ornament providing a combined function of pictorial display and ornament, which has three pictorial films each mounted on planar surfaces formed adjacent to edges of a bottom surface of a truncated triangular planar shape created by cutting off an optional vertex portion of a transparent cube, so that three different associated artistic representations formed on the pictorial films can be viewed through the transparent ornament when the transparent ornament is rotated.

2. Background of the Related Art

Generally, conventional polyhedral-shaped transparent ornaments having a three-dimensional form have been manufactured by carving or molding transparent materials such as crystal and glass into various shapes. Alternatively, a stereoscopic pattern is formed by performing a laser beam machining on the inside surface of the transparent materials, so that illuminating effect can be obtained due to the refraction and reflection of light when the transparent ornament is illuminated.

However, in case of the conventional transparent ornaments, since considerable time and cost are required to carve and mold the transparent material into various forms, the manufacturing cost of the transparent ornament is significantly increased, which causes disadvantages in that the range of a consumer's choice for the purchase of the transparent ornament is narrowed, and the like.

Further, since the conventional transparent ornaments described above have been used only for the purpose of ornament using the refraction and reflection of light, an effect in which the transparent ornament is practically utilized in a daily life by adding additional functions thereto cannot be expected.

### SUMMARY OF THE INVENTION

Accordingly, the present invention has been made in view of the above-mentioned problems occurring in the prior art, and it is a primary object of the present invention to provide a polyhedral transparent ornament proving a combined function of pictorial display and ornament, which has various pictorial films formed thereon, so that artistic representations such as pictures, photographs and prints can be viewed.

To accomplish the above object of the present invention, according to the present invention, there is provided a polyhedral transparent ornament functioning as a pictorial display, including; a cubic transparent body which includes a bottom surface formed in a truncated triangular planar shape by cutting off an optional vertex portion of the cubic transparent body, three planar surfaces each formed adjacent to edges of the bottom surface, and three viewing surfaces each formed adjacent to edges of the planar surfaces; and a plurality of pictorial films each formed on a corresponding one of the planar surfaces, whereby the pictorial films are selectively viewed through the viewing surfaces.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a transparent ornament according to an embodiment of the present invention;

FIG. 2 is a perspective view showing a bottom surface of the transparent ornament according to the present invention;

FIG. 3 is a top view of the transparent ornament according to the present invention;

FIGS. 4a through 4c are front views showing a state where the transparent ornament is rotated by 180 degrees at each time; and

FIG. 5 is a perspective view of the transparent ornament according to another embodiment of the present invention.

### DETAILED DESCRIPTION OF THE PREFERRED EMBODIMENT

Hereinafter, the transparent ornament of the present invention will be described in detail with reference to the appended drawings.

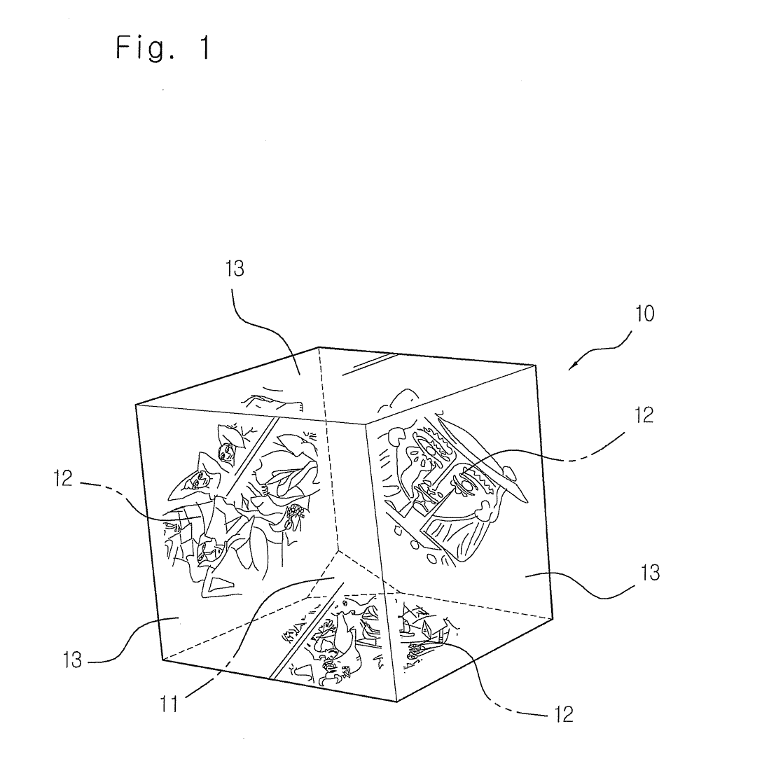

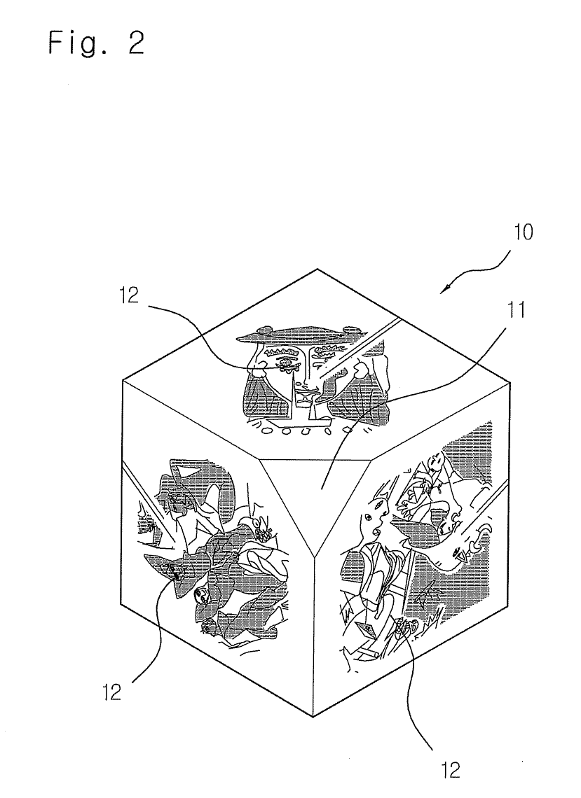

As shown in FIGS. 1 through 2, the transparent body 10 comprises a bottom surface 11 of a truncated triangular planar shape created by cutting off an optional vertex portion of a cubic transparent body 10.

The transparent body 10 can be made of materials such as acryl or glass, preferably high-quality transparent material such as crystal glass.

Each of three pictorial films 12 on the transparent body 10 is mounted on three planar surfaces formed adjacent to edges of the bottom surface 11, so that three pictorial films are selectively viewed through the other three planar surfaces, that is, viewing surfaces 13 formed without the pictorial film 12 thereon.

Each of the pictorial films 12 is formed of any one of a photograph formed by decal printing, a printed graphic, and an intaglio or relief pattern. The pictorial films 12 may be formed in more various ways.

The cubic transparent body 10 finally takes a heptahedral shape since another truncated triangular planar bottom surface 11 is created by cutting off an optional vertex portion of the cubic transparent body. Here, the remaining six surfaces excepting the bottom surface 11 to be placed on the floor are composed of three surfaces formed with three pictorial films 12 thereon and three viewing surfaces 13 formed without the three pictorial films thereon.

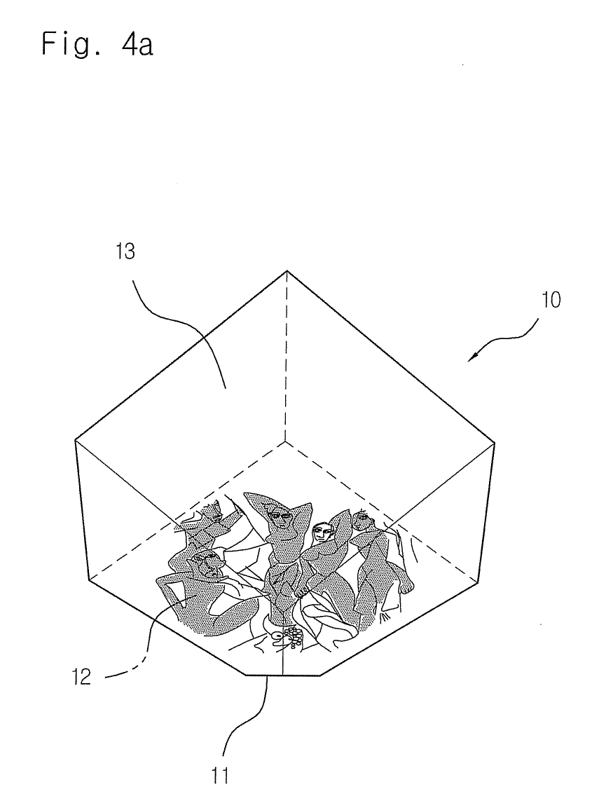

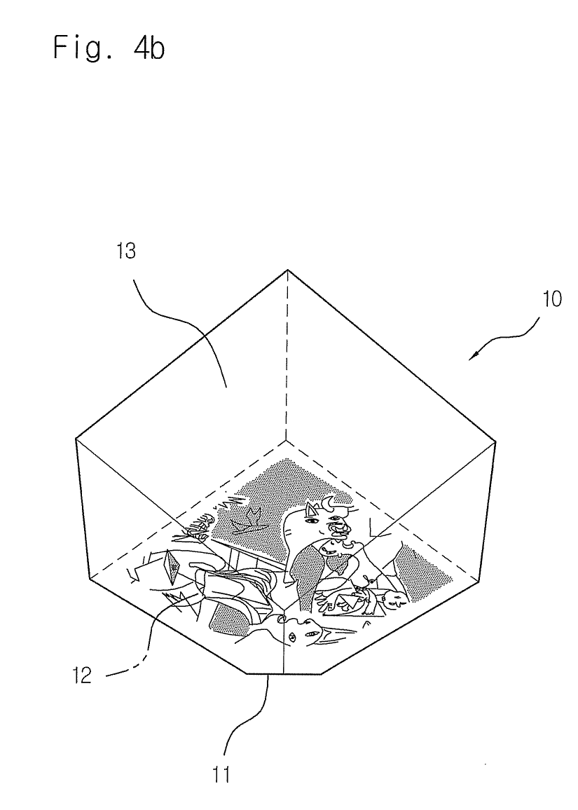

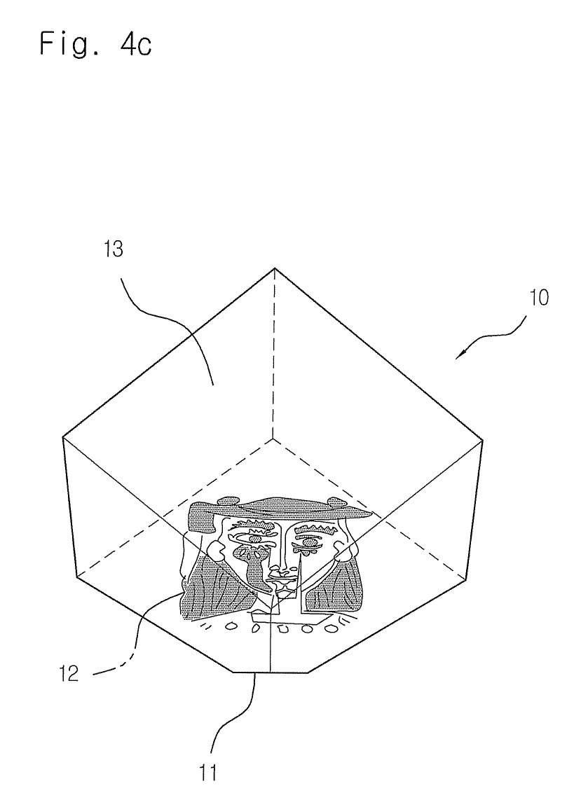

As for the present invention having the configuration described above, as shown in FIG. 4a, when a first viewing surface 13 exhibiting a rhombus shape is turned so as to face the front in the state where the bottom surface 11 of the transparent body 10 is placed on the floor, a first pictorial film 12 oriented opposite to the first viewing surface 13 is visible to a viewer through the first viewing surface 13. Further, as shown in FIG. 4b, when a second viewing surface is turned so as to face the front by rotating the transparent body 10 by 180 degrees, a second pictorial film 12 arranged opposite to the second viewing surface 13 is visible to the viewer through the second viewing surface 13, and then as shown in FIG. 4c, when a third viewing surface 13 is turned so as to face the front by rotating the transparent body 10 by 180 degrees, a third pictorial film 12 arranged opposite to the third viewing surface 13 is visible to the viewer through the third viewing surface 13. Thus, each of the three pictorial films 12 is viewed through a corresponding opposite viewing surfaces 13, resulting in functioning as a pictorial display.

FIGS. 4a through 4c are front views by the orthographic projection method in which the pictorial film 12 is substantially visible at the typical height of the viewer's eye only through the rhombus-shaped viewing surface 13, although it is illustrated seeming to be partially visible to the viewer through two lower side pictorial film-formed surfaces downwardly extending from both lower edges of the rhombus-shaped viewing surface 13. Consequently, each pictorial representation of the pictorial films is substantively viewed through the corresponding viewing surface, to thereby function as a pictorial display.

Moreover, three different associated pictorial representations of the pictorial films 12 provide a unique visual effect as a function of pictorial display.

For example, family photographs, favorite artist's paintings, and other favorite photographs or paintings may be used for three different associated pictorial representations, so that the transparent ornament can be functioned both as a pictorial display and an ornamented article, which evokes a purchase desire to modern consumers, to thereby promote the selling of the transparent ornament.

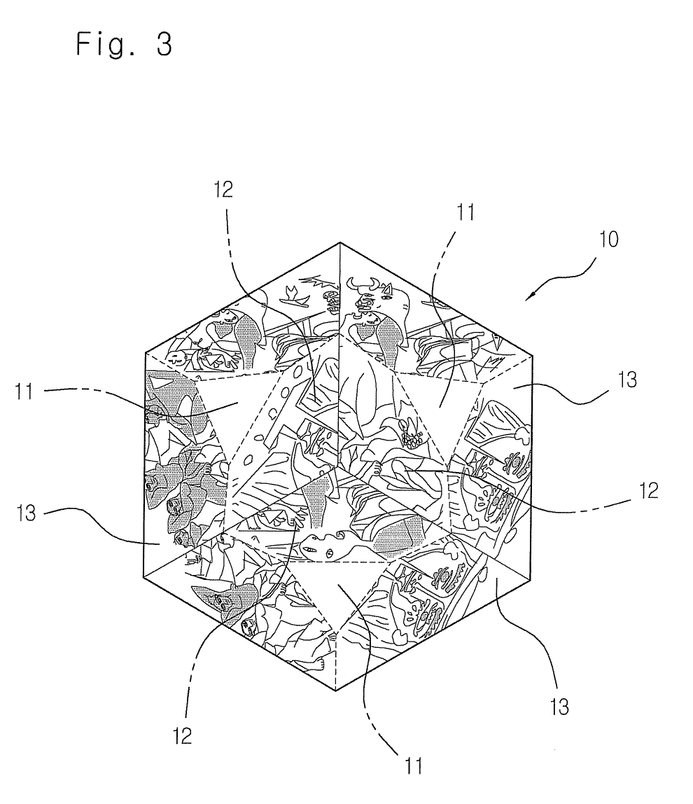

Moreover, as shown in FIG. 3, when viewing vertically from the above of the transparent body 10, three pictorial films 12 are simultaneously visible to the viewer through three inclined-viewing surfaces 13 due to an optical phenomenon caused by the refraction and reflection of light. Thus, the pictorial films of the transparent ornament may be viewed in variety ways according to angles of the viewer's eye, to thereby improve the aesthetic effect.

Further, when the transparent body 10 is illuminated by a light source, the pictorial films are more clearly and dramatically viewed due to the contrast of the projected image, to thereby provide an additional aesthetic appeal, so that the transparent ornament can be utilized in various ways.

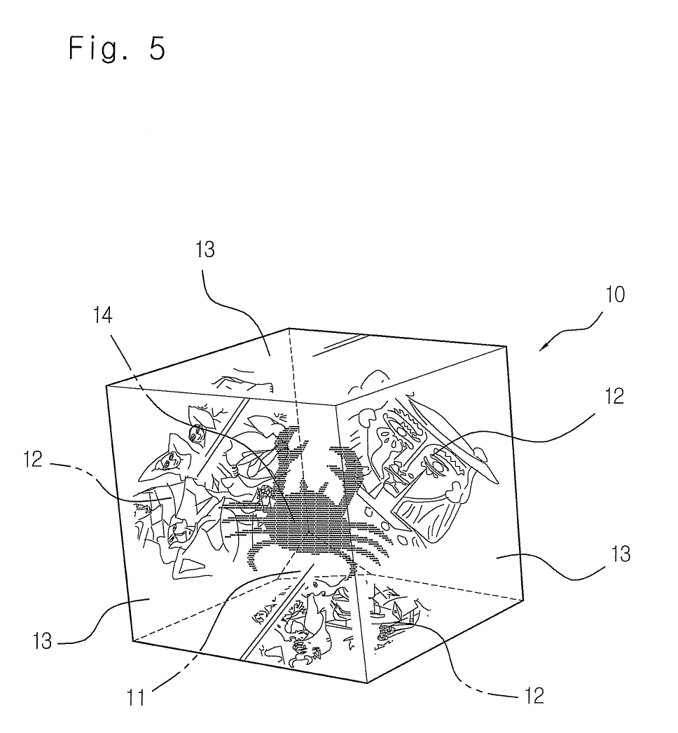

Meanwhile, as shown in FIG. 5, a stereoscopic pattern 14 may be, if necessary, formed by performing a laser beam machining on an inside of the transparent body 10, to thereby increase an ornament effect, as well as provide a more unique stereoscopic effect, in which the stereoscopic pattern 14 is viewed as if being floated in the air by making the pictorial films 12 as the background, when viewing the pictorial films 12 through the viewing surfaces 13.

As described above, according to the present invention, when a viewer rotates the transparent body 10 by 180 degrees at each time or moves her or his viewing point in the state where the transparent body 10 is placed on the floor, each of three pictorial films is substantively viewed to the viewer through a corresponding opposite rhombus-shaped viewing surfaces 13, so that the transparent ornament can be functioned both as a pictorial display having a high quality and an ornament capable of being displayed in various ways. Therefore, the transparent ornament has advantages in that, since a stereoscopic decoration effect, by which a high grade is embodied, is acquired, a purchase desire of the modern consumers may be satisfied, to thereby strengthen product competitiveness of the transparent ornament.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A polyhedral transparent ornament functioning as a pictorial display, comprising;
a cubic transparent body which includes a bottom surface formed in a truncated triangular planar shape by cutting off an optional vertex portion of the cubic transparent body, three planar surfaces each formed adjacent to edges of the bottom surface, and three viewing surfaces each formed adjacent to edges of the planar surfaces; and
a plurality of pictorial films each formed on a corresponding one of the planar surfaces,
whereby the pictorial films are selectively viewed through the viewing surfaces.

2. The transparent ornament according to claim 1, wherein each of the pictorial films is formed of any one of a photograph formed by decal printing, a printed graphic, and an intaglio or relief pattern.

3. The transparent ornament according to claim 1, wherein a stereoscopic pattern is formed in the inside of the transparent body by performing a laser beam machining.
